(19) United States
(12) Patent Application Publication
(10) Pub. No.: US 2014/0119863 A1
(43) Pub. Date: May 1, 2014

(54) RECONFIGURABLE PARTITION FOR COMPARTMENTALISING A SPACE WITHIN A VEHICLE

(71) Applicants: Stephen Hill, Penrith (GB); Hilary Anna Thornley, Penrith (GB)

(72) Inventors: Stephen Hill, Penrith (GB); Hilary Anna Thornley, Penrith (GB)

(21) Appl. No.: 14/118,020

(22) PCT Filed: May 17, 2012
(86) PCT No.: PCT/GB2012/051107

§ 371 Date: Nov. 15, 2013

(30) Foreign Application Priority Data
May 17, 2011 (GB) 1108242.7

(51) Int. Cl. B60P 1/43

(52) U.S. Cl. CPC B60P 1/43
USPC 414/537

(57) ABSTRACT

A reconfigurable vehicle partition for compartmentalising a space within a vehicle is disclosed. The partition comprises a frame which is arranged to extend within an interior of the vehicle and which is arranged to support a gate, the gate comprising a plurality of pivotally interconnected panels which are reconfigurable between a folded gate configuration and an unfolded gate configuration. The gate is arranged to pivot with respect to the frame between a closed configuration in which the gate extends substantially within the frame to partition the vehicle, and an open configuration, in which the gate extends out of the plane of the frame. In the closed configuration, the gate is arranged to extend across the frame in a substantially folded configuration, and in the open configuration the gate is arranged to extend out of the plane of the frame in the unfolded configuration to provide a ramp access into and out from the vehicle.

The present invention relates to a reconfigurable partition for compartmentalising a space within a vehicle.

The boot space of a vehicle is often used to transport items. Occasionally, the item or items may require securing within the boot space when the boot lid or tailgate is open, and on these occasions it is desirable to provide a barrier across the boot space opening to prevent the items from falling from the boot space, for example.

There also exists a problem whereby it may not be easily possible or desirable for an item to be transferred from ground level into the boot space or vice versa. For example, if the transported item is a dog then it may be too large or heavy for the owner to manually lift into the boot space. It may similarly be undesirable for the dog to jump into the boot space of its own accord because of possible scratching or muddy footprints on the vehicle paintwork.

According to an aspect of the present invention there is provided a reconfigurable vehicle partition for compartmentalising a space within a vehicle, the partition comprising:

a frame which is arranged to extend within an interior of the vehicle and which is arranged to support a gate, the gate comprising a plurality of pivotally interconnected panels which are reconfigurable between a folded gate configuration and an unfolded gate configuration,

the gate being arranged to pivot with respect to the frame between a closed configuration in which the gate extends substantially within the frame to partition the vehicle, and an open configuration, in which the gate extends out of the plane of the frame,

wherein in the closed configuration, the gate is arranged to extend across the frame in a substantially folded configuration, and in the open configuration the gate is arranged to extend out of the plane of the frame in the unfolded configuration to provide a ramp access into and out from the vehicle.

The partition thus enables a dog for example to be suitably housed within a vehicle, when the gate closes the frame, while also providing a ramp access when the gate is unfolded, to enable a dog to enter and exit the vehicle of its own accord. The skilled reader will also recognise that the partition enables a user to pass items into and out from the vehicle using the ramp, and to secure the items within the vehicle for transportation for example, when the gate is closed.

Preferably, the frame comprises a first and second side member and a base member which extends between the side members.

Preferably, the frame further comprises biasing means disposed upon the first and second side members for biasing the frame into contact with an interior of the vehicle, to secure the frame within the vehicle.

The biasing means preferably comprises an arm which is arranged to retractably extend from the respective side member into abutment with an interior of the vehicle. Preferably, each arm comprises an external thread which is arranged to separately cooperate with an internal thread disposed at a distal end of the respective side member. Alternatively, the biasing means may preferably comprise an arm which is biased into abutment with an interior of the vehicle by a spring.

Preferably, each arm comprises a cap disposed at a distal end thereof, which is arranged to contact the interior of the vehicle and to minimise any wear and/or damage to the interior of the vehicle.

Preferably, the gate is pivotally coupled to the frame at a first and second pivot point disposed upon the first side member, and a third pivot point disposed upon on the base member.

Preferably, the first pivot point is located substantially at an intersection of the first side member with the base member. This enables the gate to be reconfigured between the open configuration and the closed configuration without the need to completely decouple the gate from the frame.

Preferably, the pivot points comprise a ball and socket type coupling and preferably comprise a resilient socket coupled to the frame and a rigid ball connected to the gate. The resilient socket is preferably fabricated from toughened plastic or similar resilient material. The rigid ball is preferably fabricated from metal or similar rigid material. This enables detachable coupling of the gate to the frame while maintaining secure and stable coupling when the ball is fully received within the socket.

Preferably, the gate is detachably coupled to the second side member. This enables the gate to be secured in the closed configuration.

Preferably, the gate further comprises a locking mechanism for locking the panels of the gate in the folded and unfolded configuration. The locking mechanism is arranged to lock the relative orientation of the panels, so that the gate can carry a load when arranged as a ramp in the unfolded configuration, for example.

An embodiment of the invention will now be described in detail, by way of example only, with reference to the accompanying drawings, in which:

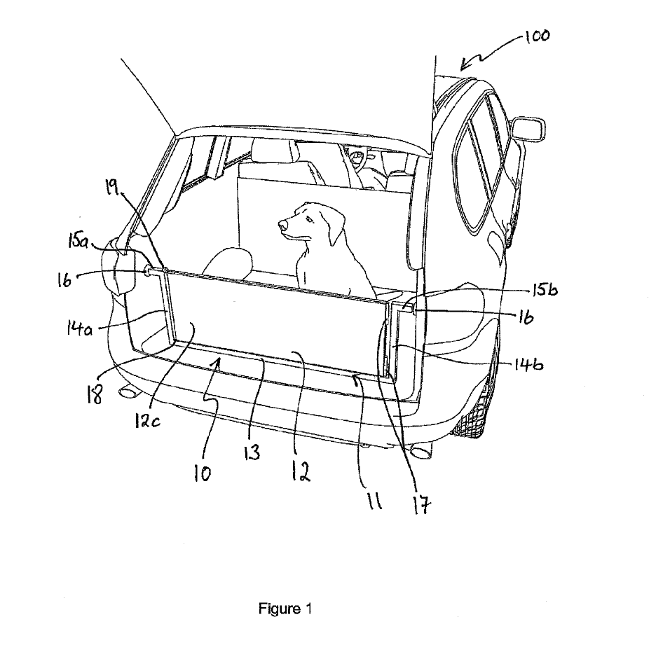

FIG. 1 is a perspective view of a reconfigurable partition according to an embodiment of the present invention, arranged in a folded configuration and disposed within a boot space of a vehicle;

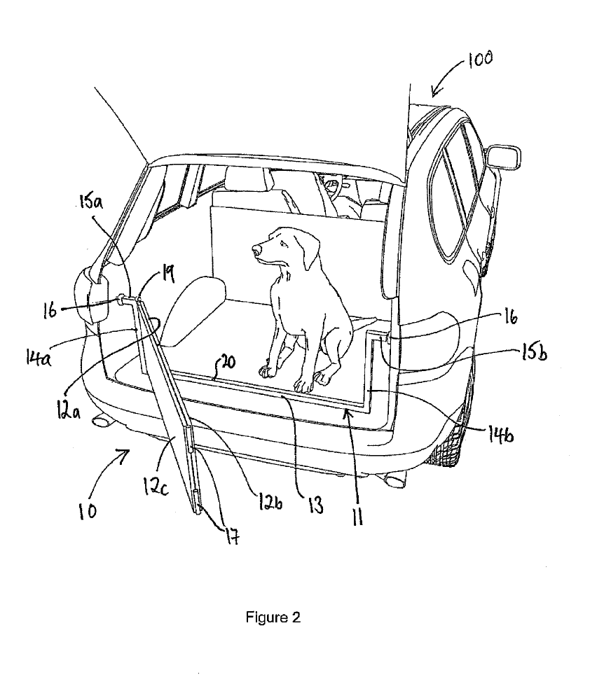

FIG. 2 is a perspective view of the partition illustrated in FIG. 1, illustrating the gate reconfigured intermediate the open and closed configurations;

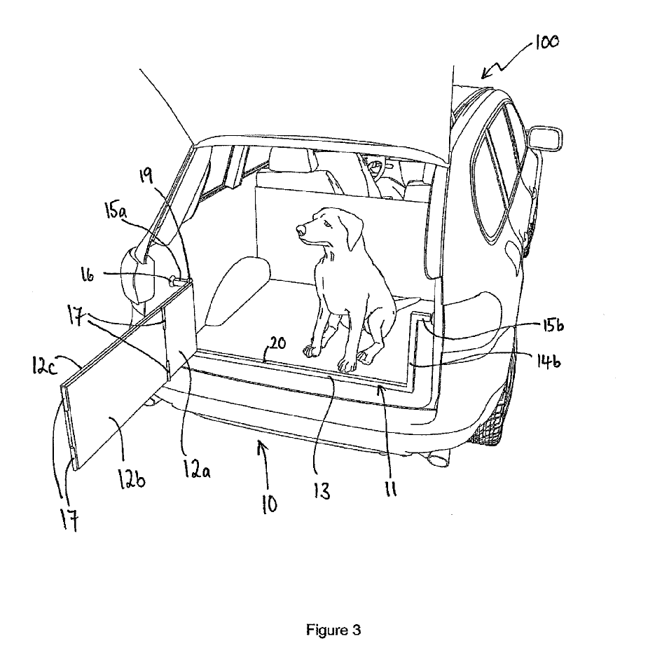

FIG. 3 is a perspective view of the partition illustrated in FIG. 1, illustrating the gate in an open configuration;

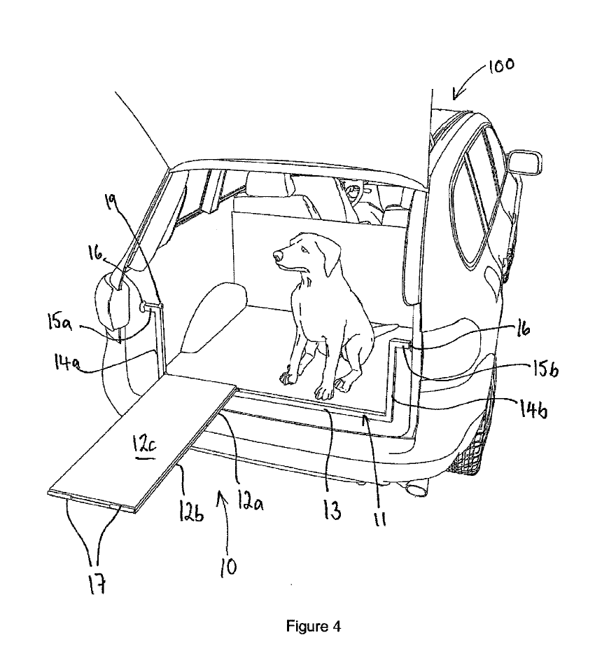

FIG. 4 is a perspective view of the partition illustrated in FIG. 1, with the gate arranged to unfold to the unfolded configuration;

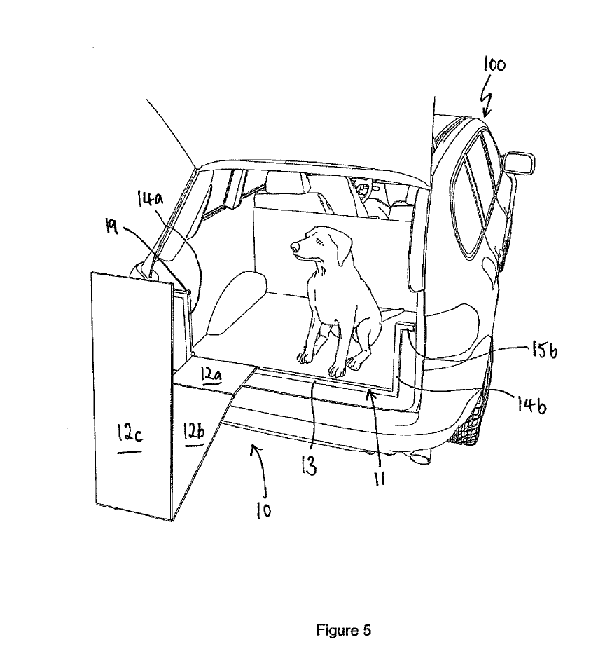

FIG. 5 is a perspective view of the partition illustrated in FIG. 4, with the gate arranged in a partially unfolded configuration;

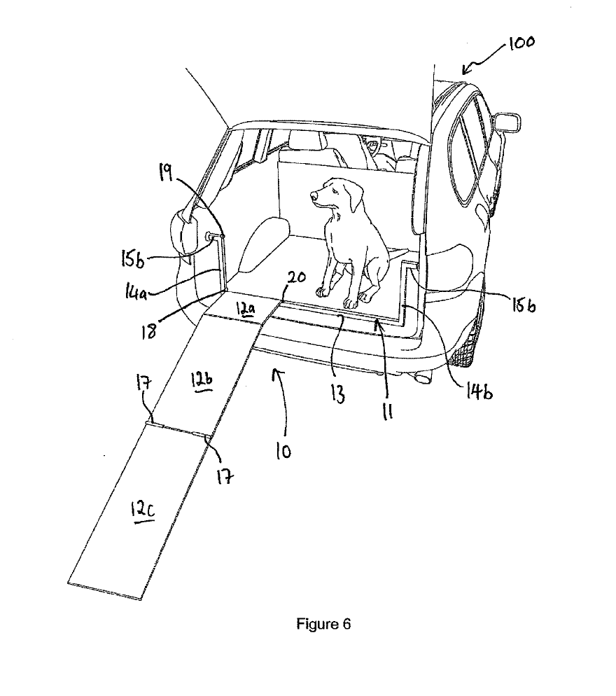

FIG. 6 is a perspective view of the partition illustrated in FIG. 4, illustrating the gate arranged in an unfolded configuration;

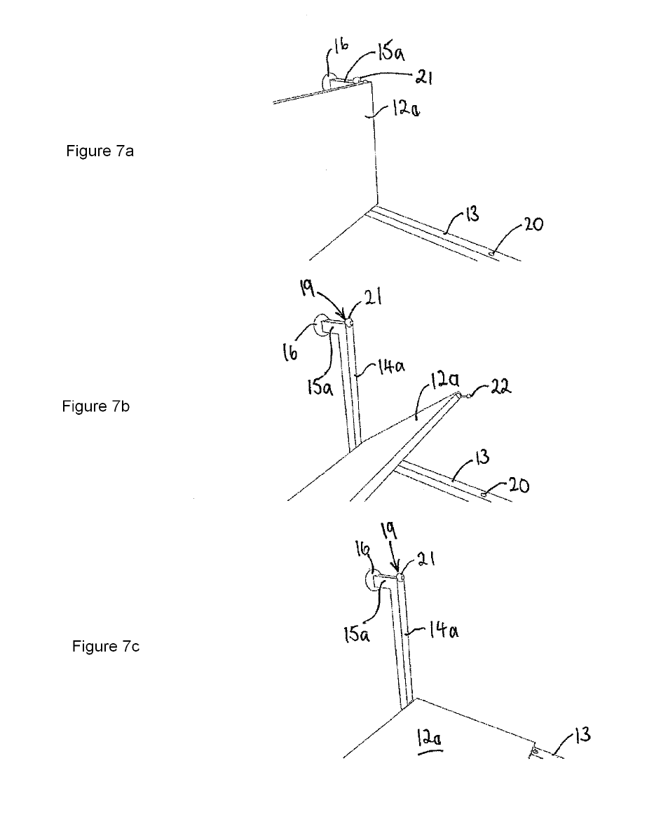

FIG. 7a is a perspective view of the partition illustrated in FIG. 1, illustrating the gate pivotally coupled to the frame at a first and second pivot point disposed upon the first side member;

FIG. 7b is a perspective view of the partition illustrated in FIG. 7a, following detachment of the gate at the second pivot point; and,

FIG. 7c is a perspective view of the invention of FIG. 7b, following coupling of the gate to the third pivot point.

Referring to FIGS. 1 to 7 of the drawings, there is illustrated a reconfigurable partition 10, according to an embodiment of the present invention, for compartmentalising a space within a vehicle 100.

The reconfigurable partition 10 comprises a frame 11 and a gate 12, which is pivotally coupled to the frame 11. The frame 11 is substantially U-shaped and comprises a base member 13 which is arranged to extend across a boot space, and a first and second side member 14a, 14b, which are separately coupled at a proximal end thereof, at opposite longitudinal ends of the base member 13, and which are arranged to extend substantially perpendicularly to the base member 13. The base member 13 comprises at least one foot (not shown) which is arranged to retractably extend from the base substantially perpendicularly thereto toward the floor of the boot space, to space the base member 13 from the floor of the boot space. The at least one foot (not shown) may comprise a pad (not shown) or similar which is arranged to contact the floor of the boot space to minimise any wear and/or damage to the interior of the vehicle 100.

The frame 11 further comprises a first and second arm 15a, 15b disposed at a distal end of each of the first and second side members 14a, 14b respectively, which are arranged to retractably extend outwardly of the frame 11 to bias the frame 11 into abutment with an interior of the vehicle 100. The arms 15a, 15b comprise an internal thread (not shown) disposed therein which is arranged to receive an externally threaded peg (not shown) so that the peg (not shown) can screw into and out from the respective arm 15a, 15b. The distal end of the respective peg (not shown) comprises a cap 16, which is arranged to contact the interior of the vehicle 100 and thus minimise any wear and/or damage to the interior of the vehicle 100. In an alternative embodiment, the pegs (not shown) and thus the caps 16, may be biased into abutment with an interior of the vehicle 100 by spring means (not shown).

In the embodiment illustrated in the figures, the gate 12 comprises a first, second and third, substantially rectangular panel 12a, 12b, 12c which are pivotally interconnected along lateral side edges thereof. The combined area and shape of the first and second panel 12a, 12b is arranged to substantially match the shape and area of the third panel 12c, such that when the panels 12a, 12b, 12c are arranged in a folded gate configuration, the first and second panels 12a, 12b extend across the third panel 12c to provide a substantially uniform gate 12. In this respect, the first 12a and second panels 12b separately comprise a reduced area compared with the third panel 12c.

The panels 12a-c are pivotally coupled by a plurality of hinges 17, which permit the panels 12a, 12b, 12c to reconfigure between a folded configuration, in which the first and second panels 12a, 12b extend in substantially the same plane, and across the third panel 12c, and an unfolded configuration, in which the panels 12a-c extend in substantially different planes. The gate 12 is further arranged to pivot in the folded configuration, with respect to the frame 11 between a closed configuration (as illustrated in FIG. 1 of the drawings) in which the gate 12 extends substantially within the frame 11, to partition the interior of the vehicle 100, and an open configuration (as illustrated in FIGS. 3 to 7 of the drawings), in which the gate 12 extends out of the plane of the frame 11.

Referring to FIG. 1 of the drawings, there is illustrated a gate 12 arranged in a folded configuration, which extends across the frame 11, between side members 14a, 14b to close the frame 11. The gate 12 and in particular the first panel 12a, is pivotally coupled at a first longitudinal end thereof, to the frame 11, at a first pivot point 18 located substantially at an intersection of the first side member 14a with the base member 13. The first panel 12a is further pivotally and detachably coupled at a second pivot point 19 disposed at a distal end of the first side member 14a. The gate 12 and in particular the second panel 12b, is further pivotally and detachably coupled at a second longitudinal end thereof to the second side member 14b at a locking point (not shown) to enable the gate 12 to be secured in the closed configuration.

The partition 10 further comprises a third pivot point 20 disposed upon base member 13 at a distance from the first pivot point 18 substantially equal to the distance between the first and second pivot points 18, 19.

The pivot points 18, 19, 20 and locking point (not shown) comprise a resilient socket 21 coupled to the frame at the respective position, and a rigid ball 22 which is disposed upon corresponding positions on the gate 12 to detachably couple with a socket 21. The resilient socket 21 may be fabricated from toughened plastic or similar resilient material, whereas the rigid ball 22 may be fabricated from metal or similar rigid material. This enables detachable coupling of the gate 12 to the frame 11 while maintaining secure and stable coupling when the ball 22 is fully received within the respective socket 21.

In the closed gate configuration, the gate 12 is arranged to extend substantially in the plane of the frame 11 and is coupled to the frame 11 at the first and second pivot points 18, 19 and at the locking point (not shown). In order to reconfigure the gate 12 to the open configuration and ultimately to the unfolded configuration, the gate 12 is uncoupled from the locking point (not shown) and pivoted out of the plane of the frame 11 about the first and second pivot points 18, 19. The gate 12 is pivoted out of the plane of the frame 11 until it extends substantially perpendicular to the plane of the frame 12. The gate 12 and in particular the first panel 12a is then uncoupled from the second pivot point 19 and pivoted about the first pivot point 18, to couple with the third pivot point 20, and thus the base member 13.

The gate 12 is subsequently unfolded by the pivoting the third panel 12c with respect to second panel 12b, and subsequently pivoting the second panel 12b with respect to the first panel 12a so that the third panel 12c can extend to the ground to provide a ramp access into and out from the vehicle 100. The gate 12 further comprises a locking mechanism (not shown) for locking the panels 12a-c of the gate in the folded and unfolded configuration, so that the gate 12 can carry a load in the unfolded ramp configuration, without collapsing, and for holding the panels in a folded gate configuration to provide for a secure gate 12.

The gate 12 may subsequently be reconfigured to the folded configuration and pivoted with respect to the frame 11 to the closed configuration, by reversing the above described sequence of steps.

From the foregoing therefore it is evident that the reconfigurable partition 10 provides a simple yet effective means of providing both a barrier within a vehicle and a ramp for access to and from a vehicle.

1. A reconfigurable vehicle partition for compartmentalising a space within a vehicle, the partition comprising:
a frame which is arranged to extend within an interior of the vehicle and which is arranged to support a gate, the gate comprising a plurality of pivotally interconnected panels which are reconfigurable between a folded gate configuration and an unfolded gate configuration,
the gate being arranged to pivot with respect to the frame between a closed configuration in which the gate extends substantially within the frame to partition the vehicle, and an open configuration, in which the gate extends out of the plane of the frame,
wherein in the closed configuration, the gate is arranged to extend across the frame in a substantially folded configuration, and in the open configuration the gate is arranged to extend out of the plane of the frame in the unfolded configuration to provide a ramp access into and out from the vehicle.

2. A partition according to claim 1, wherein the frame comprises a first and second side member and a base member which extends between the side members.

3. A partition according to claim 2, wherein the frame further comprises biasing means disposed upon the first and second side members for biasing the frame into contact with an interior of the vehicle, to secure the frame within the vehicle.

4. A partition according to claim 3, wherein the biasing means comprises an arm which is arranged to retractably extend from the respective side member into abutment with an interior of the vehicle.

5. A partition according to claim 4, wherein each arm comprises an external thread which is arranged to separately cooperate with an internal thread disposed at a distal end of the respective side member.

6. A partition according to claim 4, wherein the biasing means comprises an arm which is biased into abutment with an interior of the vehicle by a spring.

7. A partition according to claim 4, wherein each arm comprises a cap disposed at a distal end thereof, which is arranged to contact the interior of the vehicle and to minimise any wear and/or damage to the interior of the vehicle.

8. A partition according to claim 2, wherein the gate is pivotally coupled to the frame at a first and second pivot point disposed upon the first side member, and a third pivot point disposed upon on the base member.

9. A partition according to claim 8, wherein the first pivot point is located substantially at an intersection of the first side member with the base member.

10. A partition according to claim 8, wherein the pivot points comprise a ball and socket type coupling.

11. A partition according to claim 10, wherein the socket comprises a resilient socket which is coupled to the frame and a rigid ball connected to the gate.

12. A partition according to claim 2, wherein he gate is detachably coupled to the second side member.

13. A partition according to claim 1, further comprising a locking mechanism for locking the panels of the gate in the folded and unfolded configuration.

14. A partition according to claim 13, wherein the locking mechanism is arranged to lock the relative orientation of the panels.
